(19) United States
(12) Patent Application Publication
(10) Pub. No.: US 2022/0176280 A1
(43) Pub. Date: Jun. 9, 2022

(54) WATER FILTER

(71) Applicant: Qingdao Ecopure Filter Co., Ltd, Qingdao (CN)

(72) Inventor: Zou Zhibin, Qingdao (CN)

(21) Appl. No.: 17/110,433

(22) Filed: Dec. 3, 2020

(51) Int. Cl. B01D 35/30; B01D 29/23; B01D 27/14

(52) U.S. Cl. CPC B01D 35/306; B01D 29/23; B01D 27/146; B01D 2221/02; B01D 2201/4061; B01D 2201/295; B01D 2201/304; B01D 2201/302; B01D 2201/325; B01D 2201/0415

(57) ABSTRACT

A water filter cartridge is provided. The water filter cartridge includes a filter housing enclosing a filtration material therein. The filtration material includes a first cavity generally surrounded by the filtration material and a second cavity formed between an interior of the housing and an exterior of the filtration material.

### TECHNICAL FIELD

The present disclosure relates generally to water filter assemblies and systems, and more particularly, to a water filter cartridge, which may be used with water filtering systems (e.g., a refrigerator water filtration system) to treat fluids and/or liquids (e.g., water) to be dispensed therefrom.

### BACKGROUND

Water filtration systems, for example, refrigerator water filtration systems, have become popular as they assist to produce cleaner and better tasting water. Some of these water filtration systems typically use water filters (e.g., a replaceable water filter cartridge) for filtering any water dispensed therefrom. Traditional water filter cartridges are provided with a filtering media, for example, a block of activated carbon or other granular filtration media, within a casing of the water filter cartridge to enhance water filtration capability. These traditional water filter cartridges also include water ports for feeding and dispensing water at least partially disposed in the casing with the filtering media. The water filter's filtering media can adsorb or remove contaminants such as sand, rust, and cysts within the flow of water prior to delivering water and/or ice to a user (e.g., via the refrigerator's water dispenser or ice maker).

Unfortunately, due to the complexity of the filtration process, and specifically, the flow path and flow rate of existing systems, the water filtering process is generally slow, which in some instances, may compromise the water filters performance, for example, due to an over saturation of the water filter with the filtered contaminates.

Accordingly, there is an unmet need for an improved water filter to further enhance water filtration by improving the filtering process flow rate and speed.

### SUMMARY

In an exemplary embodiment, a water filter for use with an appliance is provided. The water filter includes a filtration material and a filter housing. The filter housing includes an opening portion and a first accommodating space to accommodate the filtration material therein. The filter housing defines a first cavity surrounded by the filtration material and a second cavity formed between an interior of the filter housing and an exterior of the filtration material. The water filter also includes a housing cap coupled to an upper portion of the filter housing. The housing cap includes a second accommodating space corresponding to the first accommodating space and in fluid flow intercommunication with the first accommodating space. Additionally, the water filter includes an upper supporter accommodated in the second accommodating space of the housing cap and defining a channel in fluid flow communication with an inlet of a filtration head. The upper supporter is coupled to the filtration material, and includes a supporter accommodating portion coupled to the filtering member. A supporter extending portion is also provided, and extends from the supporter accommodating portion. The supporter extending portion defines a filter inlet flow path interconnected with the channel and is configured to guide unfiltered water to the first cavity of the filter housing. The upper support also includes a projecting portion formed at an upper portion thereof and a guide groove defined around the projecting portion to engage with the filtration head to rotate the filtration head. Additionally, the projecting portion defines a fluid inlet therein to intercommunicate with an inlet of the filtration head, the channel and the filter inlet flow path of the supporter extending portion.

In yet a further exemplary embodiment, a water filter cartridge is provided. The water filter cartridge may include a filter housing with a filtration media enclosed therein. The filter housing defines an opening at an upper portion thereof and a first accommodating space therein. A filtration material is disposed within the first accommodating space and arranged for filtering water. The filter housing includes a first cavity surrounded by the filtration material and a second cavity formed between an interior of the filter housing and an exterior of the filtration material. The water filter cartridge also includes a housing cap sized and/or otherwise shaped to cover the opening of the filter housing. The housing cap defines a second accommodating space therein that corresponds to the first accommodating space of the filter housing. The housing cap further includes an upper support to assist with stabilizing the filtration material. The upper support defines a channel that is interconnected with the first cavity. The water filter cartridge also includes an inlet port disposed in an upper portion of the upper support of the housing cap. The inlet port is configured to allow unfiltered water into the filter housing through the channel and the first cavity. The water filter cartridge also includes an outlet port interconnected with the second cavity and configured for dispensing filtered water from the filter housing and the housing cap through the second cavity. The upper support further includes a supporter extending portion extending therefrom. The supporter extending portion defines a filter inlet flow path interconnected with the channel and the first cavity to guide unfiltered water from the inlet port through the channel to the first cavity of the filter housing.

In yet a further exemplary embodiment, a water filter assembly is provided. The water filter assembly may include a filter housing with filtration media enclosed therein. The filter housing defines an opening at an upper portion thereof. The filter housing also includes an accommodating space for accommodating the filtration media therein. The filter housing includes a first cavity surrounded by the filtration material and a second cavity formed between an interior of the filter housing and an exterior of the filtration material. The water filter assembly also includes a housing cap sized and/or otherwise shaped to cover the opening of the filter housing. The housing cap includes an upper support to assist with stabilizing the filtration material and defines a channel that is interconnected with the first cavity. The water filter assembly further includes a filtration head. The filtration head includes an inner pipe that is at least partially accommodated in the upper end of the upper support. The inner pipe may be rotatably connected to the upper supporter. The upper supporter comprises a projecting portion formed at an upper portion thereof and a guide groove defined around the projecting portion to engage with the inner pipe of the filtration head to rotate the filtration head. The projecting portion defines a fluid inlet therein to intercommunicate with an inlet of the filtration head, the channel, and the first cavity.

These and other objects, features and advantages of the present disclosure will become apparent from the following detailed description of illustrative embodiments thereof, which is to be read in connection with the accompanying drawings.

### BRIEF DESCRIPTION OF THE DRAWINGS

These and other features of the present disclosure will become better understood with regard to the following description and accompanying drawings in which:

FIG. 1 illustrates an exemplary embodiment of a water filtration system in accordance with the general inventive concepts;

FIG. 2 illustrates an exemplary embodiment of a water filter cartridge in accordance with the general inventive concepts;

FIG. 3 illustrates a cross-sectional view of the exemplary water filter cartridge of FIG. 2;

FIG. 4 illustrates a perspective view of an exemplary embodiment of a housing cap in accordance with the general inventive concepts;

FIG. 5 illustrates an underside perspective view of an exemplary embodiment of a filtration head in accordance with the general inventive concepts;

FIG. 6 illustrates an exploded view of an exemplary embodiment of a filtration head in accordance with the general inventive concepts;

FIG. 7 illustrates a cross-sectional view of an exemplary embodiment of a filtration head attached to an upper part of an exemplary water filter cartridge in accordance with the general inventive concepts; and

FIG. 8 illustrates a second cross-sectional view of the exemplary filtration head attached to the exemplary water filter cartridge of FIG. 7.

### DETAILED DESCRIPTION

The general inventive concepts will be understood more fully from the detailed description given below and from the accompanying drawings of the various aspects and implementations of the disclosure. This should not be taken to limit the general inventive concepts to the specific aspects or implementations, which are being provided for explanation and understanding only.

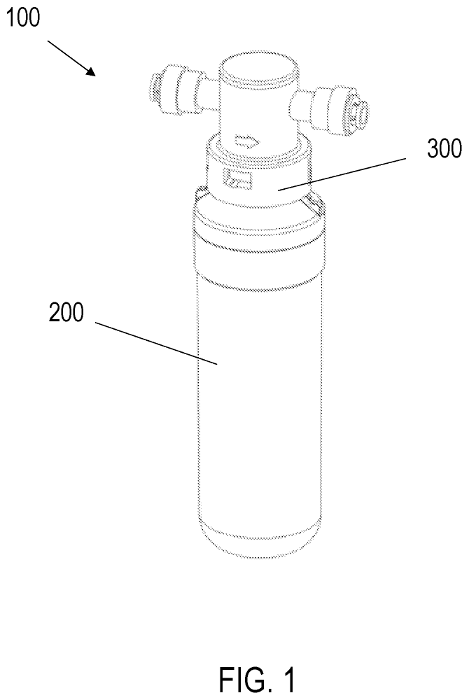

Referring now to the drawings, which are for purposes of illustrating exemplary embodiments of the general inventive concepts, and not for limiting the same, FIG. 1 illustrates an exemplary embodiment of an improved water filtration system 100.

The water filtration system 100 may include at least a water filter cartridge 200 (also referred to as a water filter) and a filtration head 300 (also referred to as a head).

In some embodiments, the water filter cartridge 200 may be a replaceable internal water filter cartridge 200 for use with a household and/or industrial appliance (e.g., a refrigerator appliance). In some embodiments, the filtration head 300 may be an adapter (e.g., a dispensing adapter) of the appliance. Additionally, or alternatively, the filtration head 300 may be a filtration part installed inline and between a water source and a dispensing unit (e.g., a faucet or dispenser of the appliance) via one or more water supply tubes (not shown).

The filtration head 300 may be sized or otherwise shaped to interface with or otherwise be connected to the water filter cartridge 200 (e.g., at an upper end of the water filter cartridge 200). The filtration head 300 may be operably configured to feed (dispense) unfiltered water into the water filter cartridge 200 from a water source (not shown), and to dispense (or otherwise facilitate the dispensing of) filtered water from the water filter cartridge 200 via one or more feed tubes (not shown).

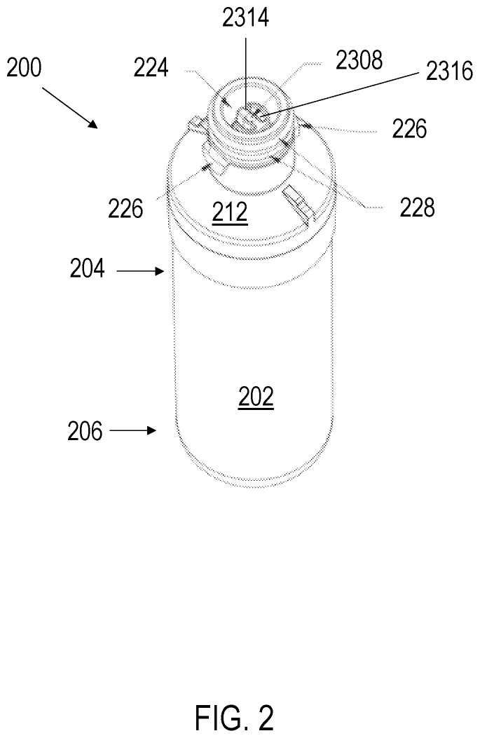

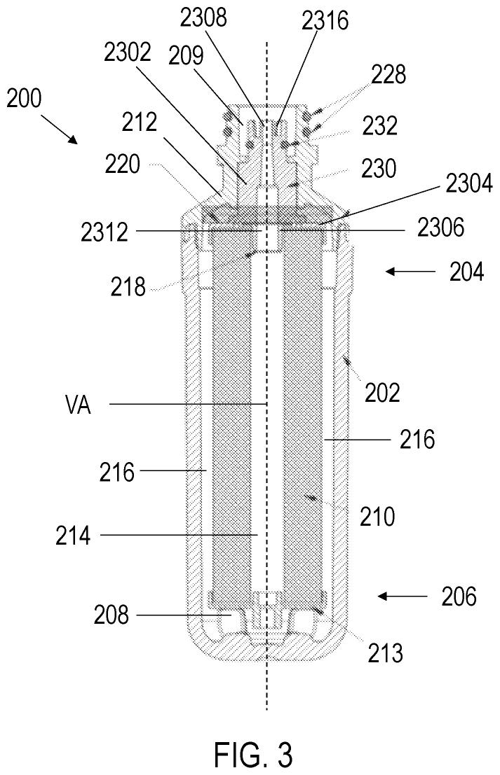

With reference now to FIGS. 2-4, the water filter cartridge 200 may include at least a filter housing 202 having an upper end 204 and a lower end 206 defined along a vertical axis VA (FIG. 3) of the water filter cartridge's 200. In some embodiments, the water filter housing 202 may be hollow (or include hollow portions) and may define a first accommodating space 208 for arranging a filtration material 210 therein.

In some embodiments, the filter housing 202 may be substantially cylindrical and/or have a tubular-like shape. Additionally, or alternatively, the filter housing 202 may be sized to fully enclose the filtration material 210 therein.

In some embodiments, the water filter cartridge 200 may include a housing cap 212 sized and/or otherwise shaped to cover an opening of the filter housing 202, for example, at an upper end of the filter housing 202. The housing cap 212 may also enclose the filtration material 210 within the filter housing 202.

In some embodiments, the water filter cartridge 200 may include a bottom cap 213 size and/or otherwise shaped to cover a bottom of the filter housing 202. It should be appreciated that the housing cap 212, the bottom cap 213 and/or the filter housing 202 may be formed from the same or similar materials, or in some embodiments, from different materials. Additionally, or alternatively, one or more of the housing cap 212 and bottom cap 213 may be integrally formed with the filter housing 202, or in some embodiments, be operable secured to the housing via a fastener and/or other fastening means known to persons of ordinary skill in the art.

It should be appreciated that the first accommodating space 208 may also be sized or otherwise shaped for containing both source water and filtered water. It should be appreciated that purified or filtered water as used herein is defined as source water that has flowed through the filtration material 210.

In some embodiments, the first accommodating space 208 may also be sized or otherwise shaped to receive or otherwise enclose one or more additional parts of the water filter cartridge 200 therein. The additional parts may include, for example, parts for positioning and/or otherwise securing the filtration material 210 within the filter housing 202, or one or more fasteners (not shown) for selectively securing parts forming the water filter cartridge 200. It should be appreciated that the additional parts for positioning the filtration material may be formed in one or more of the housing cap 212 and/or the bottom cap 213. For example, as shown in FIG. 3., an upper support 230 is accommodated in a second accommodating space 209 of the housing cap 212 to assist with stabilizing the filtration material 210 and to engage the water filter cartridge 200 with the filtration head 300, for example, when it is connected to the filtration head 300.

The upper support 230 includes a shaft 2302, a supporter accommodating portion 2304 extending along an outer the circumference of a bottom of the shaft 2302 and a supporter extending portion 2306 extending from the supporter accommodating portion 2306. The shaft 2302 defines a fluid inlet 2308 at a top thereof, corresponding to water inlet (not shown) of the filtration head 300. The fluid inlet 2308 is in fluid flow intercommunication with the water inlet (not shown) of the filtration head 300.

In some embodiments, the shaft 2302 further defines a channel 2310 therethrough for unfiltered water from the inlet of the filtration head 300. The supporter extending portion 2306 defines a filter inlet flow path 2312 interconnected with the channel 2310 and configured to guide unfiltered water to the filter housing 202. The upper support 230 further includes a projecting portion 2314 formed at an upper portion of the shaft 2302, and at least one guide groove 2316 defined around the projecting portion 2314 to engage with the filtration head 300 to rotate the filtration head 300. For example, as shown in FIG. 3., the projecting portion 2314 is disposed in a center of the upper portion of the upper support 230 and the fluid inlet 2308 is disposed in the projecting portion 2314.

It should be appreciated that the at least one guide groove 2316 includes a C-shaped guide groove around and extending from opposite sides of the projecting portion 2314, or the at least one guide groove 2316 includes a pair of guide grooves 2316 extending from an end of the projecting portion 2314 to be rotatably connected to the filtration head 300. A passage (not labeled) is defined between an inner sidewall of the housing cap 212 and an outer sidewall of the upper support 230 for filtered water away from the water filter cartridge 200.

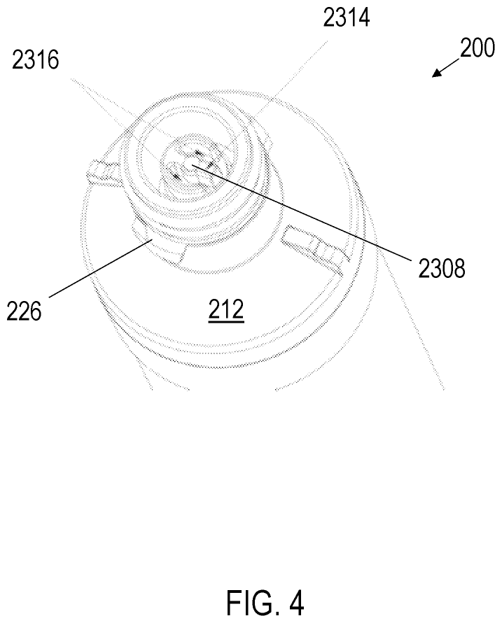

In some embodiments, the projecting portion 2314 of the upper support 230 (FIG. 4) is set between the corresponding guide grooves 2316 (FIG. 4) for providing a continuous stress surface. It should be appreciated that the projection portion 2314 is a continuous wall in the exemplary embodiments can increase the strength of stress surface between the inner pipe 304 and the upper support 230 of the water filter cartridge 200, thus improving the reliability of the water filter cartridge 200 over existing systems.

In some embodiments, the upper support 230 may include a sealing ring 232 (FIG. 3) for interfacing or otherwise connecting to the filtration head 300, or more specifically, one or more corresponding parts of the filtration head 300.

In some embodiments, the sealing ring 232 may be positioned within an upper part of the housing cap 212 where the outlet 224 may be provided. It should be appreciated that the sealing ring 232 may be positioned or arranged such that it assist with separating the source water from the filtered water.

In some embodiments, the filtration material 210 (also referred to as filtering media) may be sized or otherwise shaped for being at least partially disposed within the first accommodating space 208 for filtering the source water (e.g., unfiltered water) flowing through the water filter cartridge 200. The filtration material 210 may include activated carbon or be a carbon filter rod. Additionally, or alternatively, the filtration material 210 may include one or more alumina balls, ion-exchange resins, or combinations thereof, or other water filtering media (e.g., granular filtration media) known to persons of ordinary skill in the art for filtering source water.

With continue reference to FIG. 3, in some embodiments, a first cavity 214 may be defined in an inner space of the filtration material 210 along its vertical axis (which may be parallel to the vertical axis VA of the water filter cartridge). In some embodiments, the first cavity 214 may be narrow and may form an inflow for unfiltered source water.

Additionally, or alternatively, the first cavity 214 may be interconnected with the channel 2310 and the filter inlet flow path 2312 of the upper support 230, such that unfiltered water from the filtration head 300 can flow into the first cavity 214. As, the unfiltered water from the filtration head 300 is disposed to directly enter into the first cavity 214 through the channel 2310 and the filter inlet flow path 2312 of the upper support 230, which can provide a higher fluid flow speed and higher hydraulic pressure.

In some embodiments, a second cavity 216 may be defined between an exterior surface of the filtration material 210 and an inner surface of the housing body 202 when the filtration material 210 is arranged or otherwise positioned in the first accommodating space 208.

It should be appreciated that, in some embodiments, the first cavity 214 may have a greater space than the second cavity 216, and may be closer in distance than the distance of the second cavity 216 to the fluid inlet 2308. In addition, the fluid inlet 2308 is directly opposite to the first cavity 214, which is also can provide a better filtering rate of the water filter cartridge 200.

In some embodiments, the water filter cartridge 200 may include one or more filtering layers positioned or otherwise arranged along a flow path of the first cavity 214 and/or second cavity 216. As shown in the exemplary embodiment of FIG. 4, a first filtering layer 218 may be provided at an inlet of the first cavity 214, and a second filtering layer 220 may be provided at an outlet of the second cavity 216 to filter impurities in the water from the filtration head 300. In one exemplary embodiments, the second filtering layer 220 may be filter sponge.

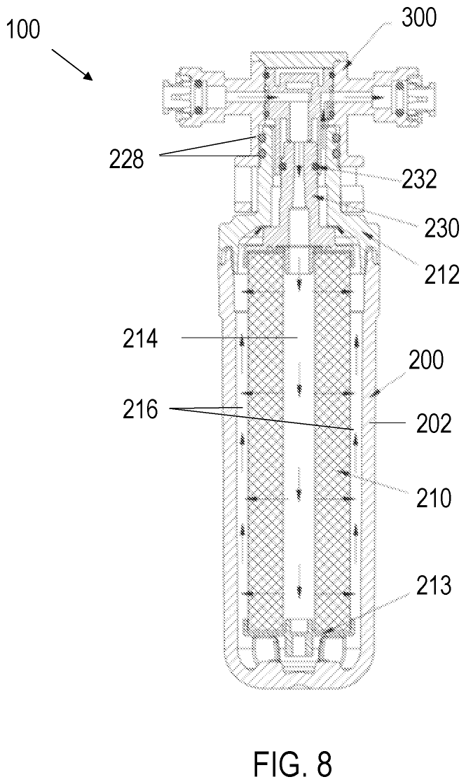

In some embodiments, the first filtering layer 218 may be attached to a bottom of the supporter extending portion 2306 of the upper support 230 so that the unfiltered water from the filtration head 300 can be filtered in a first time. As shown in the exemplary embodiment of FIG. 4 and FIG. 8, the second filtering layer 220 is attached on a surface of the supporter accommodating portion 2304 of the upper support 230, and disposed between the housing cap 212 and the upper support 230 so that the filtered water through the first cavity 214 and the second cavity 216 can be filtered again. The first filtering layer 218 can filter some particle and impurity from fluid to improve working life of the water filter cartridge 200.

Additionally, or alternatively, the first filtering layer 218 may be non-woven or gridding, and positioned or otherwise arranged for filtering out contaminants (e.g., macromolecules) in the source (unfiltered) water prior to a second filtering of the water via the second filtering layer 220.

In some embodiments, the second filtering layer 220 may include a filter cotton. It should be appreciated that purified water (i.e., water that has passed through the filtration material 210) may collect some of the filtering materials. The filter cotton can prevent theses filter materials from flowing from the water filter cartridge 200 when dispensing purified (filtered) water therefrom.

It should be appreciated that filtering water at two different points (e.g., via the first filtering layer 218 then the second filter layer 220) and at different times during the filtering process reduces the amount of absorbed materials (including contaminants) in the filtration material 210, thus prolonging the life of the water filter cartridge 200.

With continued reference to the figures, the housing cap 212 may include at least a fluid inlet 2308 for receiving source water into the water filter cartridge 200 and an outlet 224 for dispensing filtered water from the water filter cartridge 200.

As shown in FIG. 2, the upper part of the housing cap 212 may be generally cylindrical and the fluid inlet 2308 may be position at or near a center point of the housing cap 212. The fluid inlet 2308 may be aligned with the first cavity 214 and first filtering layer 218 such that source water may directly flow through the first filtering layer 218 in operation. In some embodiments, as shown in FIG. 2, the outlet 224 may be defined by the outer portions within the upper part of the housing cap 212 surrounding the fluid inlet 2308.

In some embodiments, the fluid inlet 2308 may be defined in a top of the shaft 2302 of the upper support 230, and in a center of the projecting portion 2314 formed at the upper portion of the shaft 2302. The fluid inlet 2308 is in fluid flow intercommunication with the channel 2310 of the shaft 2302 and the filter inlet flow path 2312, so that the source water can flow into the first cavity 214 through the fluid inlet 2308 and the channel 2310.

In some embodiments, the housing cap 212 may include one or more coupling projections 226 extending outwardly from an outer surface at an upper part of the housing cap 212 for connecting the water filter cartridge 200 to the filtration head 300. It should be appreciated that the filtration head 300 may include one or more grooves and/or openings 330 for receiving or otherwise connecting to the coupling projection 226. In some embodiments, the housing cap 212 may include one or more sealing rings 228 (e.g., O-rings) at an upper part of the housing cap 212. In the embodiment of FIG. 3, a pair of sealing rings 228 are provided at the upper part of the housing cap 212.

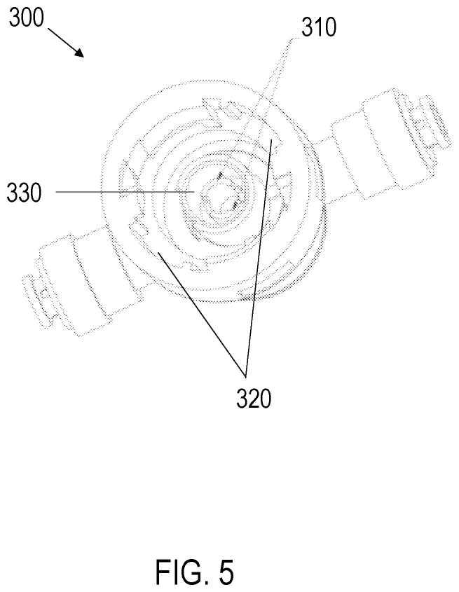

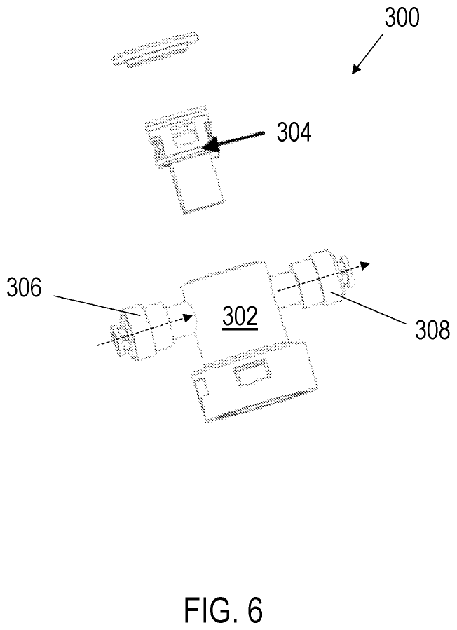

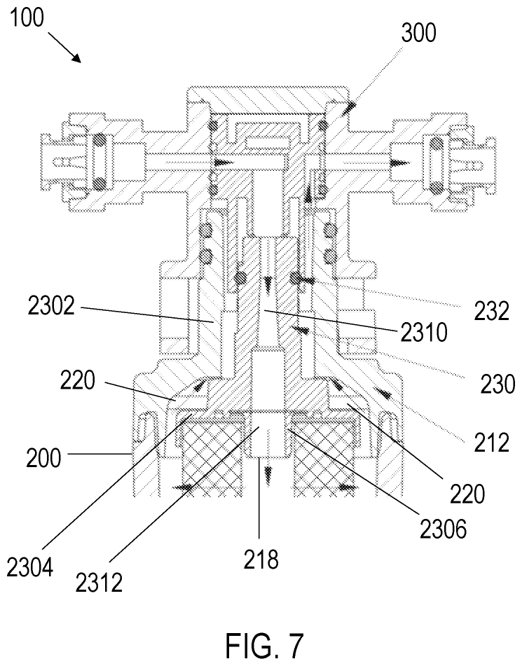

With reference now to FIGS. 5-8, the filtration head 300 may include a head housing 302 (FIG. 6) defining hollow portions and/or a cavity for at least partially enclosing an inner pipe 304 therein. The inner pipe 304 may be rotatable such that a rotation of the inner pipe 304 in a first direction and/or second direction may switch the direction of flow (e.g., waterflow).

An water inlet 306 and a water outlet 308 are disposed to opposite sides of the head housing 302, and thus forms a flow path through which water flows. The inner pipe 304 of the filtration head 300 includes a pair of protrusions 310 disposed on a lower end of the inner pipe 304, which is placed to project downward. The protrusions 310 may be sized or otherwise shaped for being at least partially received within corresponding guide groove 2316 of the upper support 230. The inner pipe 304 further includes a pair of cutoff portions 330 recessed upward and disposed on the lower end of the inner pipe 304 to adjacent to the projecting portion 2314 of the upper support 230.

In some embodiments, when the inner pipe 304 is rotated about 90 degrees in one direction, the source water may flow directly through an outlet of the head 300, and without passing through the water filter cartridge 200.

The inner pipe is rotatably connected to the upper supporter 230 when the protrusions 310 are received in the guide groove 2316 of the upper support 230. In use, the water filter cartridge 200 may be rotatable such that a rotation of the inner pipe 304 in a first direction and/or second direction may switch the direction of flow.

In some embodiments, the head housing 302 may include a pair of water supply line connectors for connecting a waterline to the filtration head 300. In the embodiment of FIG. 6, a first waterline connector 306 is provided for feeding source water into the water filter cartridge 200 and a second water waterline connector 308 is provided for delivering filtered water from the water filter cartridge 200. It should be appreciated that each of the waterline connectors (306, 308) may be size or otherwise shaped for connecting to water supply lines.

It is to be understood that the detailed description is intended to be illustrative, and not limiting to the embodiments described. Other embodiments will be apparent to those of skill in the art upon reading and understanding the above description. Moreover, in some instances, elements described with one embodiment may be readily adapted for use with other embodiments. Therefore, the methods and systems described herein are not limited to the specific details, the representative embodiments, or the illustrative examples shown and described. Accordingly, departures may be made from such details without departing from the spirit or scope of the general aspects of the present disclosure.

We claim:

1. A water filter, comprising:
a filtration material;
a filter housing comprising an opening portion and a first accommodating space to accommodate the filtration material therein, wherein the filter housing defines a first cavity surrounded by the filtration material and a second cavity formed between an interior of the filter housing and an exterior of the filtration material;
a housing cap coupled to an upper portion of the filter housing, the housing cap comprising a second accommodating space corresponding to the first accommodating space and in fluid flow intercommunication with the first accommodating space;
an upper supporter accommodated in the second accommodating space of the housing cap and defining a channel therethrough and in fluid flow communication with an inlet of a filtration head, the upper supporter coupled to the filtration material, the upper supporter comprising a supporter accommodating portion coupled to the filtering member, a supporter extending portion extending from the supporter accommodating portion, the supporter extending portion defining a filter inlet flow path interconnected with the channel and configured to guide unfiltered water to the first cavity of the filter housing; and
wherein the upper supporter comprises a projecting portion formed at an upper portion thereof, and at least a guide groove defined around the projecting portion to engage with the filtration head to rotate the filtration head, the projecting portion defining a fluid inlet therein to intercommunicate with an inlet of the filtration head, the channel and the filter inlet flow path of the supporter extending portion.

2. The water filter of claim 1, further comprising a filter outlet flow path being communicating with a bottom of the filter inlet flow path and extending along the second cavity, wherein filtered water flows through the second cavity.

3. The filter structure of claim 2, further comprising a first filtering layer disposed adjacent to the filter inlet flow path of the supporter extending portion to filter water from the inlet of the upper supporter firstly.

4. The filter structure of claim 3, further comprising a second filtering layer disposed in the second cavity and adjacent to a surface of the supporter accommodating portion to filter water flowing through the filter outlet flow path.

5. The water filter of claim 1, wherein the at least a guide groove comprises a pair of grooves defined to be symmetrical from opposite sides of the projecting portion of the upper supporter to engage with a pair of projecting portions of the filtration head to rotate the filtration head, and the projecting portion of the upper supporter being engaged with an recessed portion of the filtration head.

6. The water filter of claim 5, wherein the pair of grooves are disposed to be C-shaped to engage with a pair of projecting portions of the filtration head, and the projecting portion of the upper supporter being engaged with a pair of recessed portions of the filtration head, the recessed portions being disposed between the projecting portions of the filtration head.

7. A water filter cartridge comprising:
a filter housing having a filtration media enclosed therein, the filter housing defining an opening at an upper portion thereof and a first accommodating space therein;
and a filtration material disposed within the first accommodating space and arranged therein for filtering water, the filter housing comprising a first cavity surrounded by the filtration material and a second cavity formed between an interior of the filter housing and an exterior of the filtration material;
a housing cap sized and/or otherwise shaped to cover the opening of the filter housing, the housing cap defining a second accommodating space therein corresponding to the first accommodating space of the filter housing, the housing cap further comprising an upper support to assist with stabilizing the filtration material and defining a channel being interconnected with the first cavity;
an inlet port disposed in an upper portion of the upper support of the housing cap and configured for allowing unfiltered water into the filter housing through the channel and the first cavity;
an outlet port interconnected with the second cavity and configured for dispensing filtered water from the filter housing and the housing cap through the second cavity; and
wherein the upper support further comprises a supporter extending portion extending therefrom, the supporter extending portion defining a filter inlet flow path interconnected with the channel and the first cavity to guide unfiltered water from the inlet port through the channel to the first cavity of the filter housing.

8. The water filter cartridge of claim 7, wherein the upper support further comprises a projecting portion formed at an upper portion thereof and at least one guide groove disposed adjacent to the projecting portion, the at least one guide groove being engaging with a protrusion of a filtration head to rotate the filtration head.

9. The water filter cartridge of claim 8, wherein the inlet port is defined in the projecting portion and the at least one guide groove comprises a pair of guide grooves defined to be symmetrical from opposite sides of the projecting portion.

10. The water filter cartridge of claim 9, wherein the pair of guide grooves are disposed to be C-shaped to engage with a pair of the protrusions of the filtration head, and the projecting portion of the upper supporter being engaged with a pair of recessed portions of the filtration head, the recessed portions being disposed between the protrusions of the filtration head.

11. The water filter cartridge of claim 7, wherein a first filtering layer is disposed in the first cavity and attached on a bottom of the supporter extending portion of the upper support.

12. The water filter cartridge of claim 11, wherein a second filtering layer is disposed in the second cavity and attached on a surface of the upper support.

13. A water filter assembly comprising:
a filter housing having a filtration media enclosed therein, the filter housing defining an opening at an upper portion thereof and an accommodating space for accommodating the filtration media therein, the filter housing comprising a first cavity surrounded by the filtration material and a second cavity formed between an interior of the filter housing and an exterior of the filtration material;
a housing cap sized and/or otherwise shaped to cover the opening of the filter housing, the housing cap further comprising an upper support to assist with stabilizing the filtration material and defining a channel being interconnected with the first cavity;
a filtration head comprising an inner pipe that is at least partially accommodated in the upper end of the upper support, the inner pipe being rotatably connected to the upper supporter; and
wherein the upper supporter comprises a projecting portion formed at an upper portion thereof, and at least a guide groove defined around the projecting portion to engage with the inner pipe of the filtration head to rotate the filtration head, the projecting portion defining a fluid inlet therein to intercommunicate with an inlet of the filtration head, the channel and the first cavity.

14. The water filter assembly of claim 13, wherein the inner pipe of the filtration head comprises a protrusion received in the at least a guide groove of the upper supporter.

15. The water filter assembly of claim 13, wherein the inner pipe comprises a pair of protrusions, each of the protrusions disposed on a lower end of the inner pipe and projecting downward and accommodated in the at least a guide groove.

16. The water filter assembly of claim 15, wherein the inner pipe further comprises a pair of cutoff portions recessed upward to accommodate the pair of projecting portions, the pair of cutoff portions being disposed on the lower end of the inner pipe.
